(19) United States
(12) Patent Application Publication
(10) Pub. No.: US 2026/0339168 A1
(43) Pub. Date: Oct. 29, 2026

(54) DRIVE APPARATUS

(71) Applicant: CANON KABUSHIKI KAISHA, Tokyo (JP)

(72) Inventor: KEIKI OIKAWA, Tochigi (JP)

(21) Appl. No.: 19/574,976

(22) Filed: Mar. 23, 2026

(30) Foreign Application Priority Data
Apr. 25, 2025 (JP) 2025-073438

(51) Int. Cl. G03B 13/36

(52) U.S. Cl. CPC G03B 13/36

(57) ABSTRACT

A drive apparatus includes a first holding member that is movable and holds a first optical element; a first drive unit that drives the first holding member in the direction of the optical axis; a first guide member that guides the movement of the first holding member; a base member that holds the first guide member; a cam barrel on which a plurality of cam grooves have been provided; and a guide barrel on which a plurality of straight grooves have been provided, wherein the first drive unit is held so as to be movable in the direction of the straight grooves by the guide barrel, and also holds a first cam follower that engages with a first cam groove from among the plurality of cam grooves; the base member holds a base cam follower that engages with a plurality of base cam grooves from among the plurality of cam grooves and a base straight groove from among the plurality of straight grooves; and the first drive unit and the base member move in the direction of the optical axis due to the rotation of the cam barrel.

### BACKGROUND

### Field of the Technology

The present disclosure relates to a drive apparatus and the like for driving an optical element.

### Description of the Related Art

A lens barrel that performs magnification and focusing operations by driving a lens group in the direction of the optical axis using an electric drive means is known.

Japanese Unexamined Patent Application, First Publication No. 2024-83504 discloses a configuration for a lens barrel in which a third barrel that holds an actuator and a focus lens holding frame that is driven by the actuator is held between a first barrel that holds a first lens and a second barrel that holds a second lens.

The above-described configuration is a configuration in which the first barrel and the third barrel are driven in the direction of the optical axis by different cam grooves (a first cam groove and a second cam groove), and it is possible to independently move the third barrel in the direction of the optical axis by the rotation of a cam ring without directly holding the focus lens and the focus lens frame.

However, in the configuration that has been disclosed in Japanese Unexamined Patent Application, First Publication No. 2024-83504, a space in which to provide the cam grooves for moving the first barrel and the third barrel in the direction of the optical axis is necessary, and there is a possibility that this will hinder space saving measures.

### SUMMARY

A drive apparatus according to one aspect of the present disclosure includes a first holding member that is movable and is configured to hold a first optical element; a first drive unit configured to move the first holding member in the direction of the optical axis; a first guide member configured to guide movement of the first holding member; a base member configured to hold the first guide member; a cam barrel that has been provided with a plurality of cam grooves; and a guide barrel that has been provided with a plurality of straight grooves; wherein the first drive unit is held by the guide barrel so as to be movable in the direction of the straight grooves, and holds a first cam follower that engages with a first cam groove from among the plurality of cam grooves; wherein, the base member holds a base cam follower that engages with a plurality of base cam grooves from among the plurality of cam grooves and a base straight groove from among the plurality of straight grooves; and the first drive unit and the base member are moved in the direction of the optical axis by rotation of the cam barrel.

Further features of the present disclosure will become apparent from the following description of embodiments with reference to the attached drawings.

### BRIEF DESCRIPTION OF THE DRAWINGS

FIG. 1A. and FIG. 1B are cross-section diagrams of a lens drive apparatus according to an embodiment of the present disclosure.

FIG. 2 is a perspective diagram of a lens drive apparatus according to an embodiment of the present disclosure.

FIG. 3 is an exploded perspective diagram of a lens drive apparatus according to an embodiment of the present disclosed

FIG. 4 is an expansion diagram of a cam ring 600 according to an embodiment of the present disclosure.

FIG. 5 is a perspective diagram showing only a drive mechanism of a first lens holding frame 101 according to an embodiment of the present disclosure.

FIG. 6 is a diagram as seen from the optical axis direction of the drive mechanism of the first lens holding frame 101 according to an embodiment of the present disclosure.

FIG. 7A is an A-A cross-section diagram of the first drive unit 110 of FIG. 6, and FIG. 7B is a B-B cross section diagram of FIG. 6 for a connecting unit of a first connecting unit 105 and the first lens holding frame 101.

FIG. 8 is a diagram explaining displacements in the drive direction for the first drive unit 110, and the movement direction for the first lens holding frame 101 according to an embodiment of the present disclosure.

FIG. 9A is an A-A cross-section diagram of a first drive unit linear drive guide unit 700a according to an embodiment of the present disclosure as seen from the direction of the optical axis, and FIG. 9B is a side-view diagram of the first drive unit linear drive guide unit 700a.

FIG. 10A, and FIG. 10B are enlarged-view diagrams of a support unit of the first drive unit 110 and a guide barrel 700.

FIG. 11 is a system diagram showing a configurational example of a lens drive apparatus according to an embodiment of the present application.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions will be omitted or simplified.

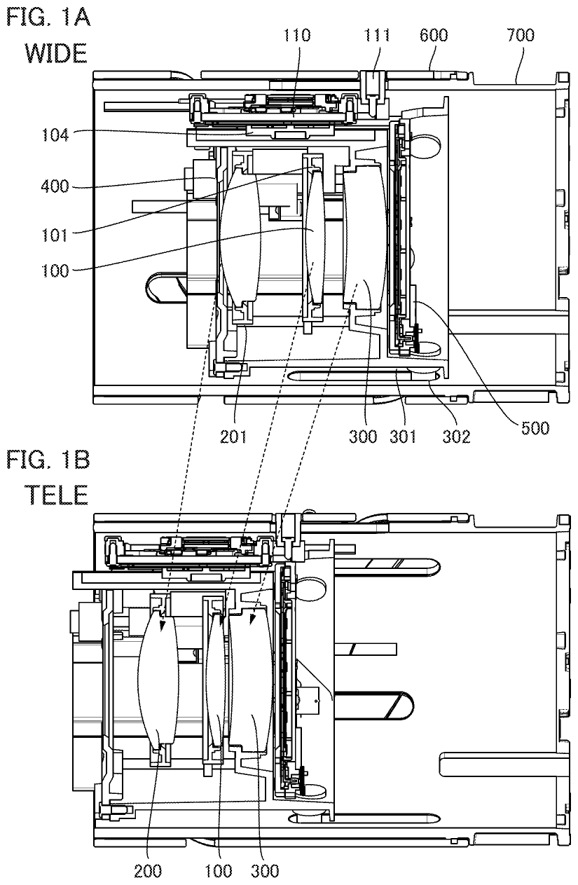

FIG. 1A, and FIG. 1B are cross-section diagrams of a lens drive apparatus that serves as a drive apparatus according to an embodiment of the present disclosure, wherein FIG. 1A shows a wide-angle end (a wide end), and FIG. 1B shows a telephoto end (a tele end).

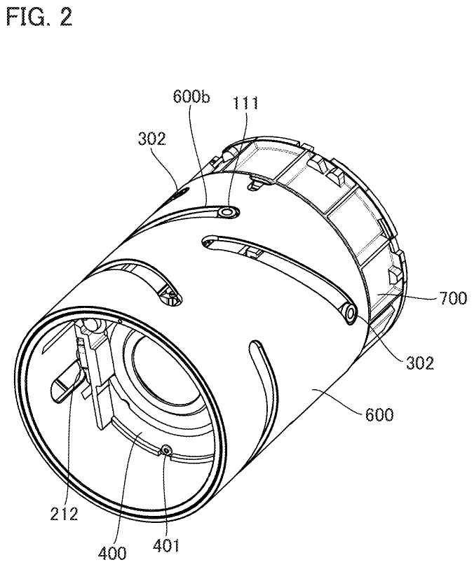

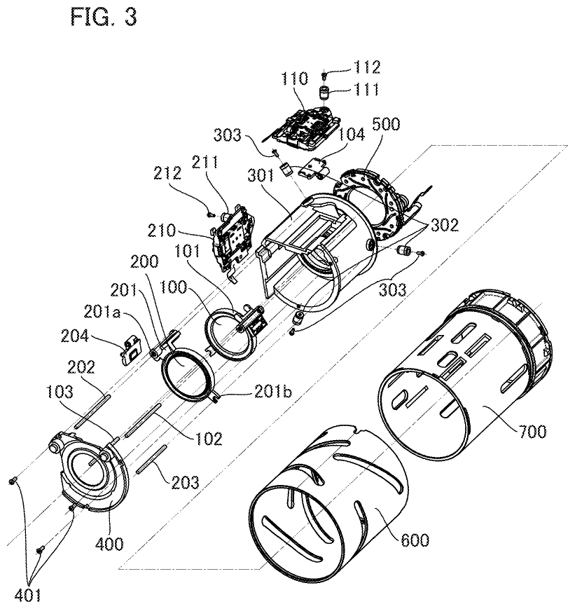

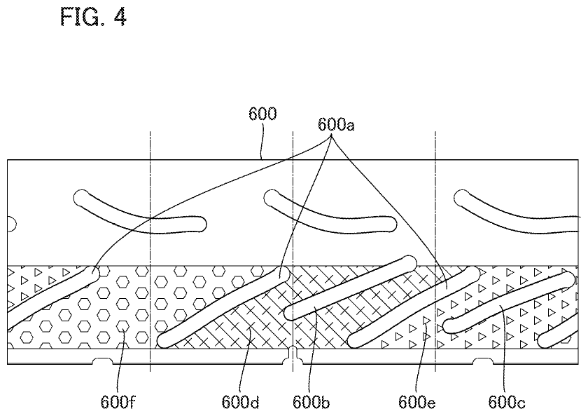

FIG. 2 is a perspective view diagram of the lens drive apparatus according to an embodiment of the present disclosure, and FIG. 3 is an exploded perspective diagram of the lens drive apparatus according to an embodiment of the present disclosure. FIG. 4 is an expansion diagram of the cam ring 600 (a cam barrel) according to an embodiment of the present disclosure, and in FIG. 4, the vertical direction is the direction of the optical axis, while the horizontal direction is the direction that is perpendicular to the optical axis.

Note that although in the embodiments described below, an example will be explained of a lens drive apparatus that serves as the drive apparatus, the drive apparatus of the present embodiment is not limited to lenses, and can also be applied to optical elements such as apertures, optical filters, and the like.

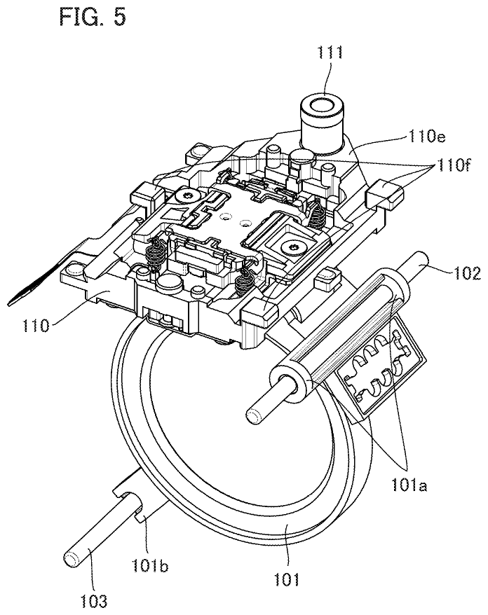

FIG. 5 is a perspective view diagram showing only the drive mechanism of the first lens holding frame 101 according to an embodiment of the present disclosure. First, the configuration of the lens drive apparatus according to an embodiment of the present disclosure will be explained using FIGS. 1 to 5.

The lens drive apparatus of the present embodiment has a first group lens 100 that serves as a first optical element, a second group lens 200 that serves as a second optical element, and a third group lens 300. The first group lens 100 is held by the first lens holding frame 101, which serves as a first holding member, the second group lens 200 is held by a second lens holding frame 201, which serves as a second holding member, and the third group lens 300 is held by a base member 301.

Note that in the present embodiment, the first group lens 100 (the first optical element) is a focusing lens (a focusing optical element), and the second group lens 200 (the second optical element), is a floating lens (floating optical element) for focusing. In addition, the third group lens 300 is a zoom lens. 500 is an aperture unit, and adjusts the amount of light for the optical system of the present embodiment. The aperture unit 500 is held by the base member 301. The cam ring 600 is rotatably held by the guide barrel 700, and is a configuration in which each of the first lens holding frame 101, the second lens holding frame 201, and the base member 301 move in the direction of the optical axis by the rotation of the cam ring 600. A detailed explanation thereof will be given below.

The first lens holding frame 101 (first holding member) holds the first group lens 100 (first optical element), and a first main guide member engaging unit 101a is supported so as to be movable in the direction of the optical axis by engagement with a first main guide bar 102.

In this context, the first main guide bar 102 functions as a first guide member configured to guide movement of the first lens holding frame (first holding member) in the direction of the optical axis. In addition, a first sub guide member engaging unit 101b engages with a first sub guide bar 103, and becomes a detent for rotation of the first lens holding frame 101 in the direction that is orthogonal to the optical axis.

The first main guide bar 102 and the first sub guide bar 103 are interposed between the base member 301 and a front cover 400. That is, the first main guide bar 102 that functions as a first guide member is supported by the base member.

The second lens holding frame 201 that serves as the second holding member holds the second group lens 200 that serves as the second optical element. In addition, in the same manner as the first lens holding frame 101, the second lens holding frame 201 is supported so as to be movable in the direction of the optical axis by the engagement of the second main guide bar engaging unit 201a and the second main guide bar 202. Note that the first lens holding frame (the first holding member) and the second lens holding frame (the second holding member) overlap in the radial direction.

In this context, the second main guide bar 202 functions as a second guide member that guides the second lens holding frame (the second lens holding member) so as to be movable in the direction of the optical axis. In addition, the second sub guide bar engaging unit 201b and the second sub guide bar 203 engage with each other, and become a detent for rotation of the second lens holding frame 201 in the direction that is orthogonal to the optical axis.

The second main guide bar 202 and the second sub guide bar 203 are interposed between the base member 301 and the front cover 400.

The third group lens 300 is held by the base member 301. The base member 301 screws down to lock and fix/hold base cam followers 302 using base cam follower locking screws 303.

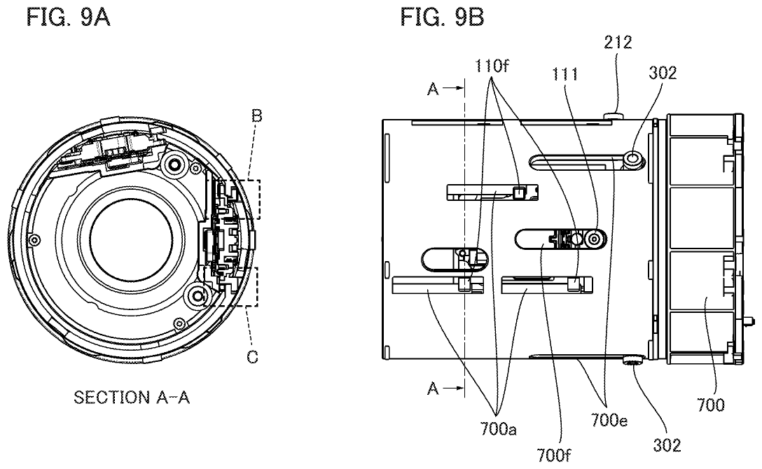

The base cam followers 302 engage with three base cam grooves 600a that have been formed on the cam ring 600, and three base straight grooves 700e that have been formed on the guide barrel 700 (refer to FIG. 9B). That is, the guide barrel 700 is provided with a plurality of straight grooves that are parallel to the direction of the optical axis. The base member 301 moves in the direction of the optical axis along the base cam grooves 600a by the rotation of the cam ring 600.

In this manner, in the present embodiment, the base member 301 holds the base cam followers 302, which engage with at least two of the base cam grooves 600a that have been provided on the cam ring 600 and the base straight grooves 700e that have been provided to the guide barrel 700.

That is, the base member holds the base cam followers, which engage with a plurality of base grooves from among the plurality of cam grooves, and a base straight groove from among the plurality of straight grooves. In addition, the first drive unit 110 and the base member 301 are configured so as to move in the direction of the optical axis according to the rotation of the cam ring 600 (cam barrel).

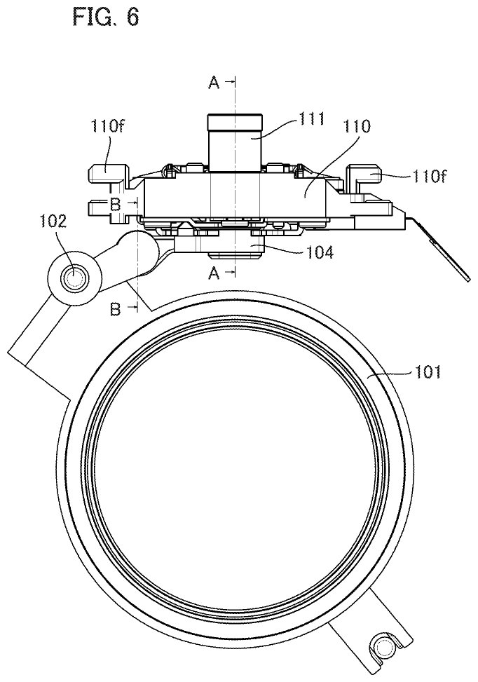

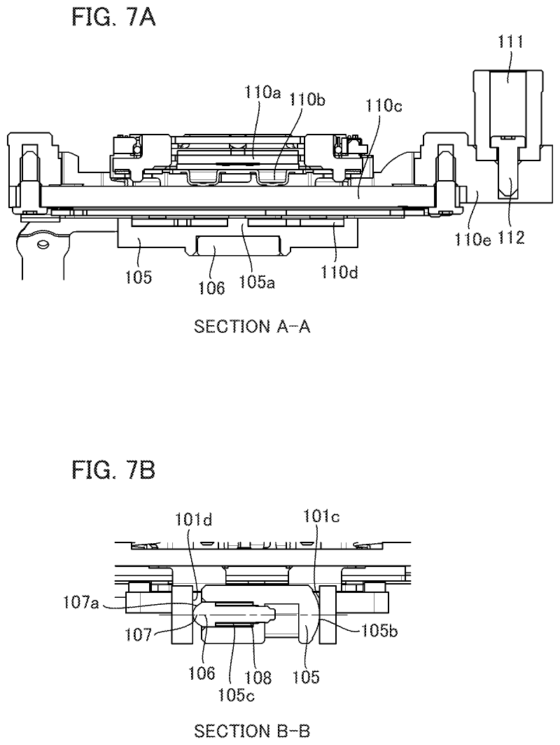

Next, the configuration for driving the first lens holding frame 101 will be explained. FIG. 6 is a diagram as seen from the direction of the optical axis of the drive mechanism for the first lens holding frame 101 according to an embodiment of the present disclosure, while FIG. 7(A) is an A-A cross section diagram of the first drive unit 110 from FIG. 6, and FIG. 7(B) is a B-B cross section diagram of a connecting unit for the first connecting member 105 and the first lens holding frame 101 of FIG. 6.

The first drive unit 110 is an actuator for driving the first lens holding frame 101 (first holding member) in the direction of the optical axis. The actuator of the present embodiment is a so-called ultrasonic motor in which a vibration plate 110b is vibrated by vibrations that are generated in a piezoelectric element 110a, and thrust for performing drive in the direction of the optical axis is created by contacting two protrusions of the vibrating plate 110b with a slider 110c, which is a friction member.

The thrust that has been generated between the vibration plate 110b and the slider 110c is transmitted to a moving plate 110d, which functions as a movable member that has been movably held to the first drive unit 110, and the thrust is transmitted to the first lens holding frame 101 by the first connecting member 105. Note that the first connecting member 105 is a member for connecting the first drive unit and the first lens holding frame (the first holding member).

The first connecting member 105 is positioned on the moving plate 110d in the movement direction by the first drive unit engaging unit 105a, and rotation about an axis in the direction that is orthogonal to the first drive unit 105a is also stopped by a shape that is not shown.

In addition, the first connecting member 105 holds a magnet 106, and the direction that is orthogonal to the contact surface of the moving plate 110d is held by a magnetic attraction force between the magnet 106 and the moving plate 110d. That is, the first connecting member 105 is held so as to move as one with the moving plate 110d, which serves as a movable unit.

Next, the configuration for transmitting the driving force to the first lens holding frame 101 by the first connecting member 105 will be explained.

The first lens holding frame 101 has a first connecting member side main contacting unit 101c, which serves as a first contacting unit, and a first connecting member side sub contacting unit 101d, which serves as a second contacting unit, that both contact the first connecting member 105. The first connecting member side main contacting unit 101c, which serves as the first contacting unit of the first lens holding frame 101 (first holding member), contacts a spherical shaped unit 105b that has been provided to the first connecting member 105, and of which the leading edge is a sphere.

In addition, a pin holding unit 105c that has been provided to the first connecting member 105 holds a biasing pin 107 that serves as a contacting member, and a biasing spring 108 that serves as a biasing member. The pin holding unit 105c functions as a contacting member holding unit. Note that the biasing spring 108 biases the bias pin 107 to the pin holding member 105c in the direction of the axis of the biasing pin 107 (the left direction in FIG. 7(B)).

The leading edge of the biasing pin 107 has a spherical shaped unit 107a with a spherical surface, and the spherical shaped unit 107a contacts the first connecting member side sub contacting unit 101d, which functions as a second contacting unit of the first lens holding frame 101 (first holding member).

In this manner, the first connecting member 105 holds the biasing spring 108, which serves as a biasing member that biases the contacting member to the second contacting unit, and which has been provided between the pin holding unit 105c that serves as a contacting member holding unit and the biasing pin 107 that serves as a contacting member.

Note that it is made such that along with the first connecting member side main contacting unit 101c being in constant contact with the spherical shaped unit 10b without any backlash therebetween due to the biasing spring 108, the biasing pin 107 and the first contacting member side sub contacting unit 101d are also in constant contact without any empty space therebetween due to the biasing spring 108.

Note that the second drive unit 210 for driving the second lens holding frame 201 (the second holding member) in the direction of the optical axis has the same configuration as the first drive unit 110. The base member holds the second guide member and the second drive unit, and the second drive unit is held by the base member so as to be movable in the direction of the optical axis. Note that the configuration of the second connecting member 205 (not shown) for connecting the second drive unit 210 and the second lens holding frame 201 (second holding member) is the same as the configuration for the first connecting member 105, and therefore, an explanation thereof will be omitted.

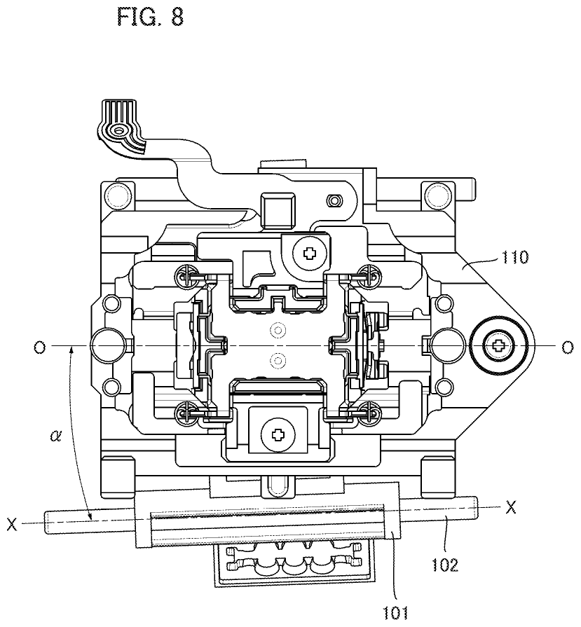

FIG. 8 is a diagram explaining displacements in the drive direction for the first drive unit 110, and the movement direction for the first lens holding frame 101 according to an embodiment of the present disclosure.

The O-O axis that is shown in the figures represents the drive direction of the first drive unit 110, the X-X axis represents the movement direction of the first lens holding frame 101, and the angle created by the O-O axis and the X-X axis becomes α.

If the movement amount for the first lens is made ΔX, the connecting unit for the first connecting member 105/biasing pin 107, the first connecting member side main connecting unit 101c, and the first connecting member side sub connecting unit 101d change to an ΔX×tan (α) Position on the O-o Axis Reference.

However, there is slip between the first connecting member side sub contacting unit 101d and the biasing pin 107 along with there being slip between the first connecting member side main contacting unit 101c and the spherical shaped unit 105b, and therefore, it is possible to effectively transmit the thrust that has been generated by the first drive unit 110 to the first lens holding frame 101.

Next, FIG. 9A is an A-A cross-section diagram of a first drive unit linear drive guide unit 700a according to an embodiment of the present disclosure as seen from the direction of the optical axis, and FIG. 9B is a side-view diagram of the first drive unit linear drive guide unit 700a, and in these diagrams, the cam ring 600 is not shown on the lens drive apparatus.

The first drive unit linear drive guide units 700a that have been provided to the guide barrel 700 are guide units that guide the first drive unit 110 in the direction of the optical axis, and the first drive unit linear drive guide units 700a are provided in three separated locations in the direction of the optical axis.

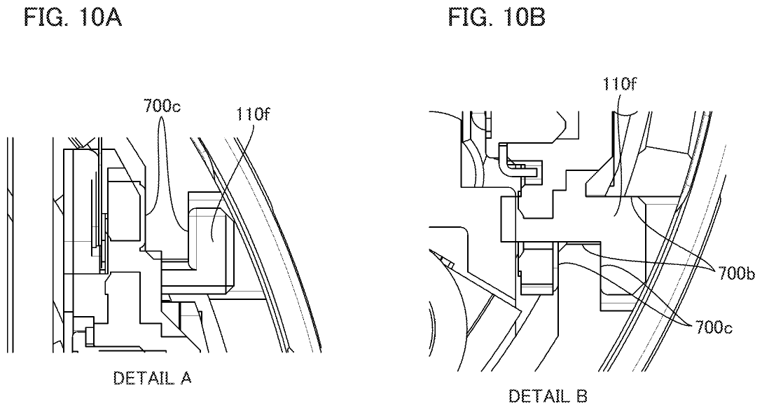

FIG. 10A, and FIG. 10B are enlarged-view diagrams of the first drive unit 110 and a support unit of the guide barrel 700, and FIG. 10 A is an enlargement of the B portion of FIG. 9(A), while FIG. 10 B is an enlargement of the C portion of FIG. 9(A).

There are guide barrel engaging units 110f (refer to FIG. 10) for the drive base 110e (refer to FIG. 5), which becomes the base member for the first drive unit 110, and optical axis direction guide units 700b provided in two separated locations in the direction of the optical axis, and the guide barrel engaging unit 110f is guided in the direction of the optical axis by the engagement of these two locations.

That is, the holding unit for the first drive unit 110 and the guide barrel 700 is held so as to be movable in the direction of the optical axis by the engagement of the plurality of grooves that have been provided on the guide barrel 700 with the guide barrel engaging unit 110f that has been provided on the first drive unit 110.

A radial direction engaging unit 700c is an engaging unit that regulates the movement in the radial direction of the drive base 110e. the radial direction engaging unit 700c engages with the guide barrel engaging unit 110f in three locations of the first drive unit linear drive guide unit 700a, and it becomes possible for the first drive unit 110 to move in the direction of the optical axis without moving in the radial direction, That is, the first drive unit 110 is held so as to be movable in the direction of the straight grooves by the guide barrel.

In addition, as is shown in FIG. 9(B) in the present embodiment, at least a portion of the first drive unit 110 and the holding unit of the guide barrel 700 overlap when seen from the direction that is orthogonal to the optical axis. In addition, as is shown in FIG. 10(A), and (B), at least a portion of the first drive unit 110 and the holding unit of the guide barrel 700 overlap in the movement region of the first drive unit 110 when seen from the direction that is parallel to the direction of the optical axis. It is possible to reduce the diameter of the first drive unit 110 due to this configuration.

However, there may also be regions in which the first drive unit 110 does not overlap with a portion of the guide barrel 700 in the movement region of the first drive unit 110.

Note that as is shown in FIG. 7(A), the first cam follower 111 is fixedly held on the drive base 110e by the cam follower locking screw 112. As is shown in FIG. 2, by engaging with the first cam groove 600b of the cam ring 600, the first cam follower 111 moves in the direction of the optical axis along the locus of the first cam groove 600b due to the rotation of the cam ring 600.

In this manner, the first drive unit 110 holds the first cam follower 111, which engages with at least the one first cam grooves 600b that has been provided on the cam ring. That is, the first drive unit holds the first cam follower that engages with the first cam groove from among the plurality of cam grooves.

Note that as is shown in FIG. 4, the first cam groove 600b is formed by less grooves than the base cam grooves 600a, and in the present embodiment, one first cam groove 600b engages with the first cam follower 111.

Note that as is shown in FIG. 9 (B), in the present embodiment, the first straight groove 700f that has been provided on the guide barrel 700 may engage with the first cam follower 111, and the first straight groove 700f that has been provided on the guide barrel 700 may also not engage with the first cam follower 111.

In addition, in the present embodiment, an explanation has been given using a configurational example that engages with the optical axis direction guide unit 700b in the same manner that is shown in FIG. 10(B) in order to hold the first drive unit 110 in the guide barrel 700 so as to be able to move in the direction of the direction of the optical axis. However, the configuration that supports the first drive unit 110 so as to be movable in the optical axis direction is not limited thereto.

For example, as the configuration in which the first lens holding frame 101 is supported so as to by movable in the direction of the optical axis, a configuration has been introduced that is supported by the first main guide bar 102 and the first sub guide bar 103 so as to be movable in the direction of the optical axis. This may also be made a configuration in which the drive base 110e is supported by the main guide bar and the sub guide bar so as to be movable in the direction of the optical axis in the same manner.

Note that the configuration of the second drive unit 210 is the same as the configuration of the first drive unit 110, and this is supported so as to be movable in the direction of the optical axis by the guide barrel 700. Note that the second cam follower 211 that has been held by the second drive unit 210 engages with the second cam groove 600c of the cam ring 600 (cam barrel), as is shown in FIG. 4, and the second drive unit 210 is moved in the direction of the optical axis by the rotation of the cam ring 600 (cam barrel).

As is shown in FIG. 4, a smaller number of second cam grooves 600c are formed than the number of base cam grooves 600a, and in the present embodiment, one second cam groove 600c engages with the cam follower 211.

Therefore, when the first drive unit 110 and the second drive unit 210 are driven, the first lens holding frame 101, which has been connected to the first drive unit 110 by the first connecting member 105, and the second lens holding frame 201, which has been connected to the second drive unit 210 by the second connecting member 205, are drive in the direction of the optical axis.

In this manner, the position of the first lens holding frame 101 is positioned by the rotation of the cam ring 600 and the drive amount of the first drive unit 110, and the position of the second lens holding frame 201 is positioned by the rotation of the cam ring 600 and the drive amount for the second drive unit 210. Therefore, it is possible to freely change the movement loci for the first cam groove 600b and the second cam groove 600c according to the optical characteristics.

For example, cam loci in which it is easy to inhibit defocusing when performing zoom may also be used. In addition, it may also be made such that the a configuration is used in which the first drive unit 110 and the second drive unit 210 move due to the rotation of the cam ring 600, and the cam loci may be made such that the length of the direction of the optical axis for the first drive unit 110 and the length of the direction of the optical axis for the second drive unit 210 become as small as possible. In addition, these two may also be balanced.

As has been explained above, by employing the configuration of the present embodiment, it is possible to set the cam loci in the optical design with a high degree of freedom.

Note that although in the present embodiment, an explanation has been given of a case in which the first drive unit is a so-called ultrasonic motor, the first drive unit is not limited to being an ultrasonic motor, and may also be a stepping motor, and a voice coil motor. It is also possible to shorten the length of the direction of the optical axis of the actuator by applying the configuration of the present embodiment in a stepping motor and a voice coil motor.

Note that in the present embodiment, as is shown in FIG. 4, it is made such that the cam loci (cam curves) for the base cam groove 600a, the first cam groove 600b, and the second cam groove 600c are all different from each other. Next, an explanation will be given of the layout of the base cam groove 600a, the first cam groove 600b, and the second cam groove 600c of the cam ring 600.

In FIG. 4, the base cam grooves 600a are provided in three phases along the circumferential direction of the cam ring (cam barrel), and the regions along the circumferential direction of the cam ring 600 (cam groove) between the three base cam grooves 600a are defined as a first region 600d, a second region 600e, and a third region 600f. That is, these three regions indicate the regions of the direction of the optical axis of the base cam grooves 600a on the cam ring 600.

In the present embodiment, a portion of the first cam grooves 600b are disposed in the first region 600d. Note that it is sufficient if at least a portion of the first cam grooves 600b are disposed in at least one region from among the first region to the third region.

In addition, the second cam groove 600c is positioned in the second region 600e. Note that it is preferable if at least a portion of each of the second cam grooves 600c is disposed in a region of any of the first to third regions that is different than the regions in which the first cam grooves 600b are disposed. Note that although in FIG. 4, there is no cam groove that has been provided so as to overlap with the third region 600f, at least a portion of the first cam groove 600b may also be disposed in the third region 600f, and at least a portion of the second cam groove 600c may also be disposed in the third region 600f.

In this manner, at least a portion of the first cam groove 600b is positioned in a region in one of the first region 600d, the second region 600e, and the third region 600f. In addition, it is preferable if at least a portion of the second cam groove 600c is disposed in a region from among the first region 600d, the second region 600e, and the third region 600f in which the first cam groove 600b is not disposed.

However, at least a portion of the first cam groove 600b and at least a portion of the second cam groove 600c may also be disposed in the same region inside of the first region 600d, the second region 600e, and the third region 600f.

In this manner, in the present embodiment, it is possible to provide the first cam grooves 600b and the second cam grooves 600c between each of the base cam grooves 600a, which determine the position in the direction of the optical axis of the drive apparatus, and it is possible to decrease the amount of space in the direction of the optical axis.

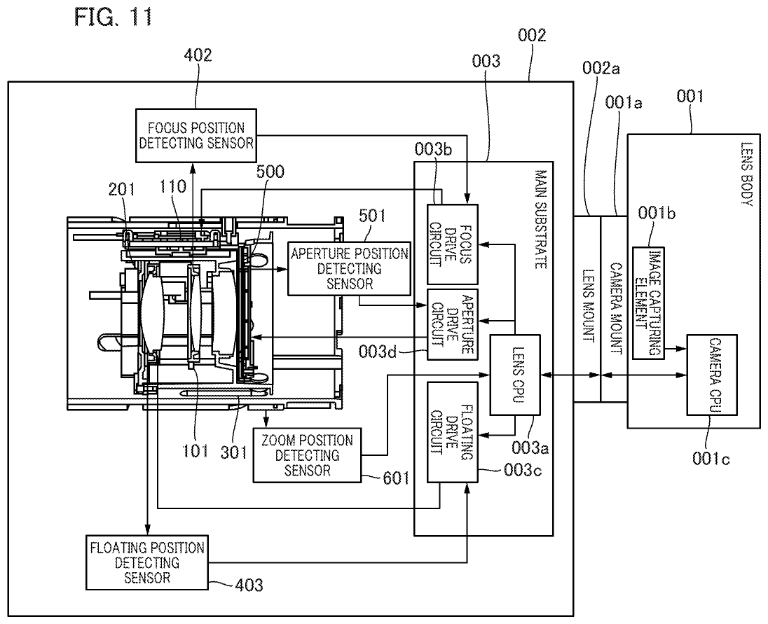

FIG. 11 is a system diagram showing a configurational example of the lens drive apparatus according to the present embodiment of the present disclosure. Note that a portion of the functional blocks that are shown in FIG. 11 are realized by a lens CPU and the like, which serves as a computer that is included in the lens drive apparatus, executing a computer program that has been stored on a memory, which serves as a storage medium, which is not shown.

However, a portion or the entirety thereof may also be made so as to be realized by hardware. As the hardware, an application specific integrated circuit (ASIC), a processor (a reconfigurable processor, a DSP), and the like, can also be used.

In addition, each of the functional blocks that are shown in FIG. 11 do not need to be housed in the same body, and may also be configured by separate apparatuses that have been connected to each other via signal path.

In the present embodiment, an example is shown of a camera system (an image capturing system) in which the lens barrel that serves as the lens drive apparatus is removably mounted onto a camera body (an image capturing apparatus body), and the present embodiment can be applied to a digital still camera, a digital video camera, and the like.

The lens barrel of the present embodiment has an image capturing optical system that forms optical images of subjects. Note that the lens drive apparatus of the present embodiment is not limited to a lens barrel for use in a camera, and may also be a lens drive apparatus for a liquid crystal projector, binoculars, a microscope and the like. 001 is a camera body, and the camera body 001 has a camera side mount 001a for holding an interchangeable lens 002, which serves as the lens drive apparatus (optical apparatus), an image capturing element 001b, a camera CPU 001c, which serves as a computer, and the like.

The camera CPU 001c has the role of performing control based on image information and autofocus-related information that have been obtained from the image capturing element 001b, and various types of input information such as operations by operating buttons that are not shown.

In addition, the camera CPU 001c transmits and receives control commands, and information relating to the state of the interchangeable lens 002 with a lens-side CPU 003a via a camera-side mount 001a and a lens-side mount 002a, and the camera CPU 001c also controls the entirety of the interchangeable lens 002, which serves as the lens drive apparatus.

The lens-side CPU 003a is mounted on a main substrate 003. In addition, a focus drive circuit 003b, a floating drive circuit 003c, an aperture drive circuit 003d, and the like are also mounted on the main substrate 003.

The focus drive circuit 003b receives information via a flexible printed circuit board, and the like, which is not shown, from a focus position detecting sensor 402 that detects the position of the first lens holding frame 101, and drives the first drive unit 110 based on a control command from the lens-side CPU 003a.

Note that the focus position detecting sensor 402 functions as a first lens position detecting unit (a first optical element position detecting unit), and detects a relative position of the first lens holding frame 101 in relation to the guide barrel 700. Conversely, the focus position detecting sensor 402 may also detect a relative position of the first lens holding frame 101 (the first holding member) in relation to the base member 301.

Note that in the present embodiment, there are cases in which there is empty space between the base cam grooves 600a and the base cam follower locking screw 303 due to the part settings. If there is empty space between the base cam grooves 600a and the base cam follower locking screw 303, there is a possibility that, for example, tilting changes will occur for the base member 301 due to changes in the posture of the lens drive apparatus.

That is, in the present embodiment, the first main guide bar 102 is held by the base member 301, and the tilt of the first lens holding frame 101 also changes by tilting together with the first main guide bar 102.

In contrast, the first drive unit 110 is held by the guide barrel 700, and it is difficult for the first drive unit 110 to be influenced by the tilt of the base member 301. That is, relative position changes occur between the first lens holding frame 101 and the base member 301.

It is also possible to correct this positional displacement using the first drive unit 110 by detecting the position of the first lens holding frame 101 in relation to the base member 301. It is thereby possible to inhibit defocusing caused by posture changes.

The floating drive circuit 003c receives information via a flexible printed circuit board and the like, which is not shown, from a floating position detecting sensor 403 that detects the position of the second lens holding frame 201, and drives the second drive unit 210 based on a control command from the lens-side CPU 003a.

Note that the floating position detecting sensor 403 functions as a second lens position detecting unit (a second optical element position detecting unit), and may also detect the relative position of the second lens holding frame 201 in relation to the guide barrel 700. In addition, the floating position detecting sensor 403 may also detect a relative position of the second lens holding frame 201 (the second holding member) in relation to the base member 301.

The aperture drive control circuit 003d receives information via a flexible printed substrate and the like that is not shown from an aperture detecting sensor 501 that detects an aperture position of the aperture unit 500, and drives the aperture unit 500 based on a control command from the lens-side CPU 003a.

A zoom position detecting sensor 601 is a sensor that detects a zoom position of the lens group. The zoom position information that has been detected by the zoom position detecting sensor 601 is transmitted to the lens-side CPU 003a, and the CPU 003a transmits drive commands to the focus drive circuit 003b, the floating drive circuit 003c, the aperture drive circuit 003d, and the like based on the zoom position information. In addition, the lens information is transmitted to the camera CPU 001c.

Note that the zoom position detecting sensor 601 performs the zoom position detection for the lens drive apparatus by detecting the rotational position of the cam ring 600, the position of the base member 301 in relation to the guide barrel 700, the rotational position of a rotational operation ring, which is not shown, that rotates the cam ring 600, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the drive apparatus and the like through a network or various storage media. Then, a computer (or a CPU, an MPU, or the like) of the drive apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-073438, filed on Apr. 25, 2025, which is hereby incorporated by reference herein in its entirety.

What is claimed is:

1. A drive apparatus comprising:
a first holding member configured to be movable and hold a first optical element;
a first drive unit configured to move the first holding member in the direction of the optical axis;
a first guide member configured to guide movement of the first holding member;
a base member configured to hold the first guide member;
a cam barrel on which a plurality of cam grooves has been provided; and
a guide barrel on which a plurality of straight grooves has been provided; wherein
the first drive unit is held so as to be movable in the direction of the straight grooves by the guide barrel, and also holds a first cam follower configured to engage with a first cam groove from among the plurality of cam grooves;
the base member holds a base cam follower configured to engage with a plurality of base cam grooves from among the plurality of cam grooves, and a base straight groove from among the plurality of straight grooves; and
the first drive unit and the base member move in the direction of the optical axis due to rotation of the cam barrel.

2. The drive apparatus according to claim 1, wherein, a locus of the first cam groove and a locus of the base cam groove are different.

3. The drive apparatus according to claim 1, wherein the base cam grooves are provided in three phases along the circumferential direction of the cam barrel, and when regions between the base cam grooves along the circumferential direction of the cam barrel are made a first region, a second region, and a third region, at least a portion of the first cam groove is disposed in a region from among any of the first region, the second region, and the third region.

4. The drive apparatus according to claim 1, wherein a holding unit for the first drive unit and a holding unit for the guide barrel are held so as to be movable in the direction of the optical axis by a plurality of grooves that have been provided on the guide barrel engaging with a guide barrel engaging unit that has been provided on the first drive unit.

5. The drive apparatus according to claim 1, wherein at least a portion of a holding unit for the first drive unit and a holding unit for the guide barrel overlap when seen from the direction that is orthogonal to the direction of the optical axis.

6. The drive apparatus according to claim 1, wherein at least a portion of a holding unit for the first drive unit and a holding unit for the guide barrel overlap in a movement region of the first drive unit when seen from the direction that is parallel to the direction of the optical axis.

7. The drive apparatus according to claim 1, further comprising a first optical element position detecting unit for detecting at least one of a relative position of the first holding member in relation to the guide barrel, or a relative position of the first holding member in relation to the base member.

8. The drive apparatus according to claim 1, further comprising a first connecting member configured to connect the first drive unit and the first holding member; wherein
the first drive unit is provided with a movable unit that is movably held to the first drive unit;
the first connecting member is held so as to move as one with the movable unit; and wherein
the first connecting member further comprises:
a spherical shaped unit configured to contact a first contacting unit of the first holding member;
a contacting member holding unit configured to hold a contacting member having a spherical shaped unit that contacts a second contacting unit of the first holding member; and
a biasing member that has been provided between the contacting member holding unit and the contacting member, and that is configured to bias the contacting member to the second contacting unit.

9. The drive apparatus according to claim 1, further comprising:
a second holding member configured to hold a second optical element;
a second guide member configured to guide the second holding member in the direction of the optical axis;
a second drive unit configured to drive the second holding member in the direction of the optical axis; and
a second connecting member configured to connect the second drive unit and the second holding member; wherein
the base member holds the second guide member and the second drive unit.

10. The drive apparatus according to claim 9, wherein the second drive unit is held by the base member so as to be movable in the direction of the optical axis, and holds a second cam follower configured to engage with at least one second cam groove that has been provided on the cam barrel; and wherein
the second drive unit moves in the direction of the optical axis by the rotation of the cam barrel.

11. The drive apparatus according to claim 10, wherein a cam locus of the first cam groove, a cam locus of the base cam groove, and a cam locus of the second cam groove are different from each other.

12. The drive apparatus according to claim 10, wherein the base cam grooves are provided in three phases along the circumferential direction of the cam barrel; and
when the regions between the base cam grooves along the circumferential direction of the cam barrel are defined as a first region, a second region, and a third region, at least a portion of the second cam groove is disposed in at least one from among the first region, the second region, and the third region.

13. The drive apparatus according to claim 9, further comprising a second optical element position detecting unit for detecting at least one of a relative position of the second holding member in relation to the guide barrel, or a relative position of the second holding member in relation to the base member.

14. The drive apparatus according to claim 9, wherein the first holding member and the second holding member overlap in the radial direction.

15. The drive apparatus according to claim 9, wherein the first optical element is a focusing optical element, and the second optical element is a floating optical element for focusing.
